(19) United States
(12) Patent Application Publication
(10) Pub. No.: US 2009/0191299 A1
(43) Pub. Date: Jul. 30, 2009

(54) MOLDING APPARATUS

(75) Inventor: Chien-Feng Huang, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/261,292

(22) Filed: Oct. 30, 2008

(30) Foreign Application Priority Data
Jan. 24, 2008 (CN) 200810300211.1

(51) Int. Cl. B28B 7/28

(52) U.S. Cl. 425/451.9

(57) ABSTRACT

A molding apparatus includes a first mold half, first mold core received in the first mold half, a second mold half including a receiving cavity defined therein, a second mold core, a spacer and a bolt. The second mold half is positioned opposite to the first mold half. A first through hole is defined in the second mold half and in communication with the receiving cavity. The second mold core is received in the receiving cavity. The second mold core defines a threaded hole in a peripheral surface thereof aligned with the first through hole. The spacer is configured for being positioned between the second mold core and the second mold half. The spacer defines a second through hole therein. The bolt passes through the first through hole and is screwed in the threaded hole for securing the second mold core to the second mold half.

### CROSS-REFERENCE TO RELATED APPLICATIONS

This application is related to commonly-assigned copending applications Ser. No. 12/251,724, entitled “MOLDING APPARATUS”, and Ser. No. ______, entitled “______” (attorney docket number US 18735). Disclosures of the above-identified application are incorporated herein by reference.

### BACKGROUND

1. Field of the Invention

The present invention relates to a molding apparatus.

2. Description of Relate Art

Molding apparatuses are widely used for manufacturing optical articles, such as light guide plates, lenses, etc. For lenses, concentricity of the two opposing surfaces is an important factor in molding precision.

Referring to FIG. 7, a typical molding apparatus 10 for molding an optical lens 12 includes a first mold part 100 and a second mold part 110 facing the first mold part 100. A first mold core 120 is mounted in the first mold part 100, and the second mold part 110 is mounted in the second mold core 130. The first mold core 120 has a first curved molding surface 122 and the second mold core 130 has a second curved molding surface 132 facing the first curved molding surface 122. A molding chamber is defined between the first molding surface 122 and the second molding surface 132.

As shown in FIG. 7, when assembling the first and second mold part 100 and 110 together, a loss of concentricity may occur between the first and second molding surface 122 and 132. This leads to difficulty in assembly and disassembly of the first and second mold parts 100 and 110, and abrasion of the mold cores 120 and 130 may occur after repeatedly use. In addition, disassembly and modification of the molding apparatus may be needed, thus reducing molding efficiency and increasing cost.

Therefore, a molding apparatus is desired to overcome the above-described deficiencies.

### SUMMARY

A molding apparatus includes a first mold half, first mold core, a second mold half, a second mold core, a spacer and a bolt. The first mold core is received in the first mold half, the first mold core having a first molding surface. The second mold half is positioned opposite to the first mold half. The second mold half includes a receiving cavity defined therein. A first through hole is defined in the second mold half and in communication with the receiving cavity. The second mold core is received in the receiving cavity of the second mold half. The second mold core has a second molding surface facing the first molding surface. The first molding surface and the second molding surface are configured for cooperatively defining a molding cavity between the first molding surface and the second molding surface. The second mold core defines a threaded hole in a peripheral surface thereof. The threaded hole is aligned with the first through hole in the second mold half. The spacer is configured for being positioned between the second mold core and the second mold half. The bolt passes through the first through hole and is screwed in the threaded hole for securing the second mold core to the second mold half.

Advantages and novel features will become more apparent from the following detailed description of the present molding apparatus, when taken in conjunction with the accompanying drawings.

### BRIEF DESCRIPTION OF THE DRAWINGS

Many aspects of the present molding apparatus can be better understood with reference to the following drawings. The components in the drawings are not necessarily drawn to scale, the emphasis instead being placed upon clearly illustrating the principles of the present molding apparatus. Moreover, in the drawings, like reference numerals designate corresponding parts throughout the several views.

FIG. 1 is an assembled isometric view of an embodiment of a molding apparatus

FIG. 2 is an exploded isometric view of the molding apparatus shown in FIG 1.

FIG. 3 is an enlarged sectional view of the molding apparatus shown in FIG 1.

FIG. 4 is cross-sectional view of a lens formed by the molding apparatus shown in FIG. 1.

FIG. 5 is a cross-sectional view of early stages of a process of a concentricity adjusting method using the molding apparatus of FIG. 1.

FIG. 6 is a cross-sectional view of latter stages of the process of the concentricity adjusting method using the molding apparatus of FIG. 1.

FIG. 7 is a cross-sectional view of a typical molding apparatus.

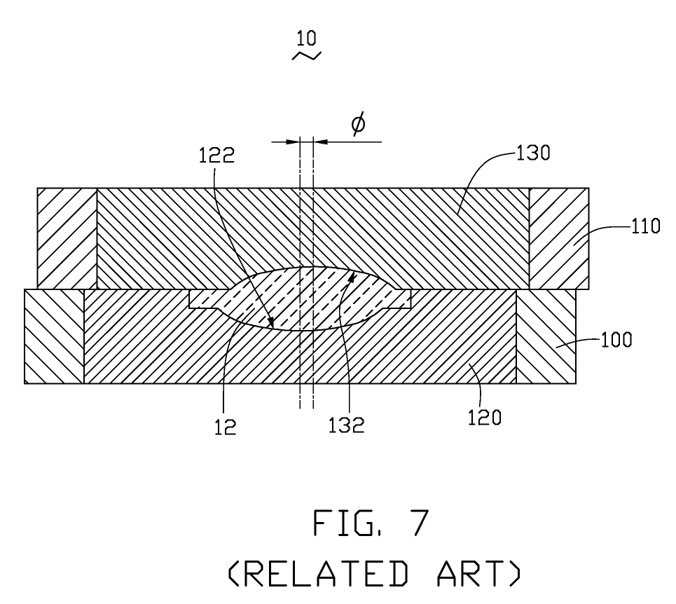

### DETAILED DESCRIPTION OF THE EMBODIMENTS

Reference will now be made to the drawings to describe embodiments of the present molding apparatus.

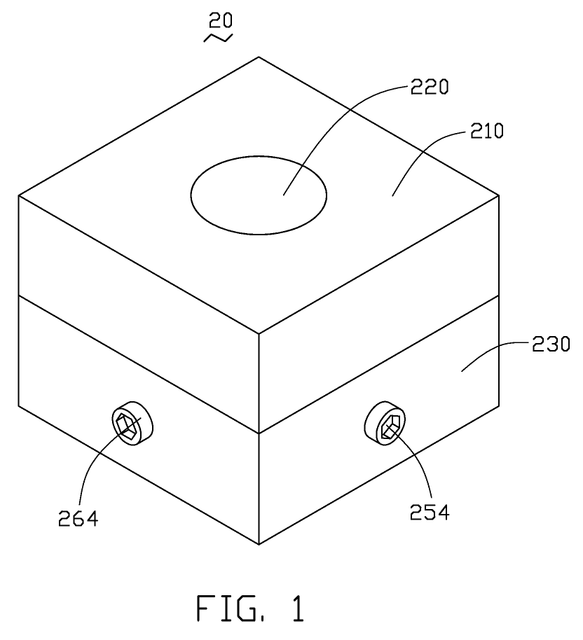

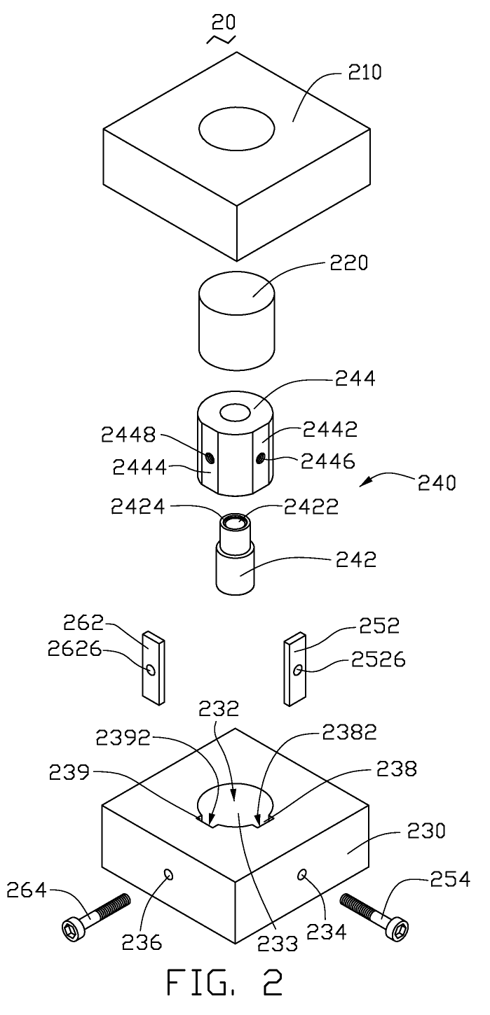

Referring to FIGS. 1 and 2, a molding apparatus 20 of an embodiment includes a first mold half 210, a first mold core 220 installed in the first mold half 210, a second mold half 230, and a second mold core 240 installed in the second mold half 230.

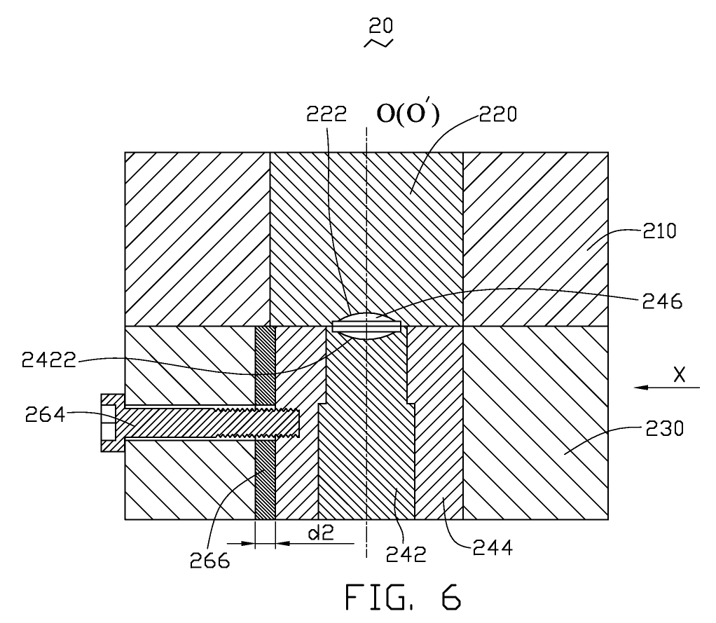

The first mold core 220 is matingly installed in the first mold half 210. The first mold core 220 has a first curved molding surface 222 with a principal axis O (see FIG. 6).

A receiving cavity 232 is defined in the second mold half 230 and extends through the second mold half 230. The second mold core 240 is received in the receiving cavity 232. The second mold core 240 includes an insert core 242 and a sleeve 244 for receiving the insert core 242. The insert core 242 is matingly received in the sleeve 244. In this embodiment, the insert core 242 has a stepped structure. The sleeve 244 is received in the receiving cavity 232. A second curved molding surface 2422 with a principal axis O′ is defined in an end face 2424 of the insert core 242(see FIG. 6).

The sleeve 244 is cylinder-shaped. The sleeve 244 has two flat side surfaces 2442 and 2444 substantially parallel with a principal axis of the sleeve 244. In this embodiment, the two flat side surfaces 2442 and 2444 are perpendicular to each other. A threaded hole 2446 is defined in the flat side surface 2442, and a threaded hole 2448 is defined in the flat side surface 2444. In this embodiment, a principal axis of the threaded hole 2446 is perpendicular to the flat side surface 2442, and a principal axis of the threaded hole 2448 is perpendicular to the flat side surfaces 2444.

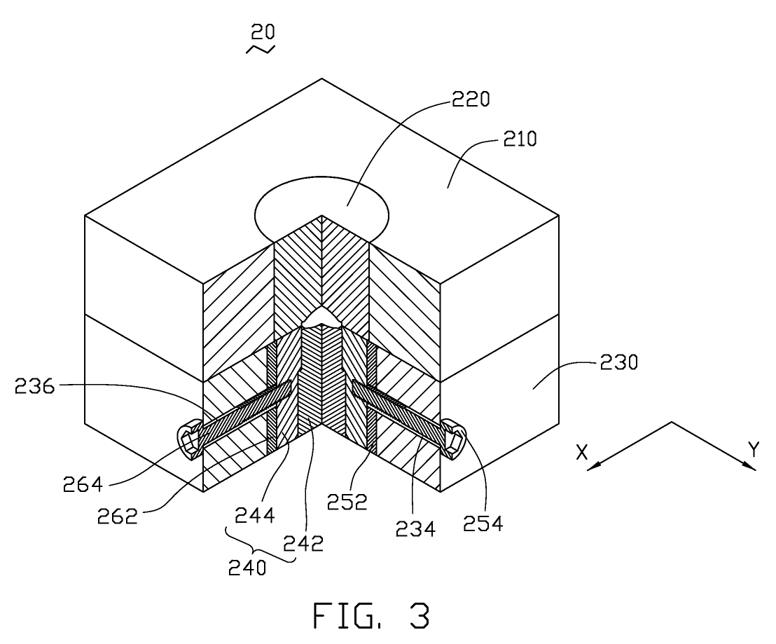

The receiving cavity 232 has a cylinder shape and is defined by an inner surface 233 of the second mold half 230. A radius of the receiving cavity 232 is greater than the radius of the sleeve 244. The radius of the receiving cavity 232 and is about 0.01 millimeter less than the radius of the sleeve 244. Two grooves 238 and 239 are defined in the inner surface 233. The grooves 238 and 239 extend along directions parallel with a principal axis of the receiving cavity 232. The groove 238 has a bottom surface 2382, and the groove 239 has a bottom surface 2392. A through hole 234 is defined in the bottom surface 2382 and a through hole 236 is defined in the bottom surface 2392. The two through holes 234 and 236 are in communication with the receiving cavity 232. In assembly, the groove 238 is arranged facing the flat side surfaces 2442, and the groove 239 is arranged facing the flat side surface 2444. The through hole 234 is perpendicular to flat side surface 2442 of the sleeve 244and the through hole 236 is perpendicular to the flat side surface 2444 of the sleeve 244 (see FIG. 3).

Referring to FIGS. 2 and 3, the first mold core 220 is installed in the first mold half 21O. The insert core 242 is installed in the sleeve 244. The sleeve 244 is installed in the receiving cavity 232 of the second mold half 230 in a manner that the two flat side surfaces 2442 are positioned correspond to the two corresponding grooves 238 and 239. The first and second mold parts 210 and 230 are assembled together. The first mold core 220 is arranged opposite to the second mold core 240 in a manner that the first molding surface 222 faces towards the second molding surface 2422.

A spacer 252 is positioned between the flat side surface 2442 and the bottom surface 2382 of the groove 238, and a spacer 262 is positioned between the flat side surface 2444 and the bottom surface 2392 of the groove 239. Two through holes 2526 and 2626 are defined in the two spacers 252 and 262. A bolt 254 is passed through the through hole 234 and the through hole 2526 in the spacer 252, and then screwed in the threaded hole 2446 in the sleeve 244. Thus, the spacer 252 contacts the flat side surface 2442 and the bottom surface 2382 of the groove 238, and the spacer 252 and the sleeve 244 are locked close. The radius of the bolt 254 is less than the radius of the through hole 234 and the radius of the through hole 2526 so that the bolt 254 can move along a direction parallel with the flat side surface 2442. A bolt 264 is passed through the through hole 236 in the second mold half 230 and the through hole 2626 in the spacer 262, and then screwed in the threaded hole 2448 in the sleeve 244. Thus, the spacer 262 contacts the flat side surface 2444 and the bottom surface 2392 of the groove 239, and the spacer 262 and the sleeve 244 are locked close. The radius of the bolt 264 is less than the radius of the through hole 236 and the radius of the through hole 2626 so that the bolt 264 can move along a direction parallel with the flat side surface 2442.

The spacers 252 and 262 can be replaced by other spacers with different thicknesses to adjust the position of the sleeve 244 in the second mold half 230, thus the position of the insert core 242 in the second mold half 230 can be adjusted. Proper thickness of the spacers allows the first molding surface 222 to be coaxial with the second molding surface 2422, and a molding cavity 246 (see FIG. 6) is defined between the first molding surface 222 and the second molding surface 2422.

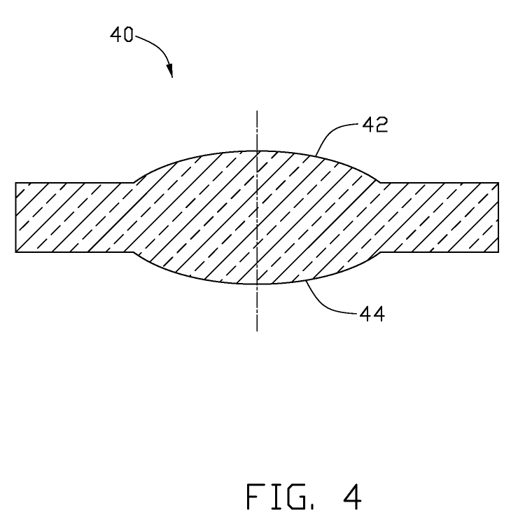

Referring to FIG. 4, a lens 40 molded by the molding apparatus 20 is shown. The lens 40 has two curved surfaces 42 and 44 opposite to each other, wherein the surface 42 is formed corresponding to the second molding surface 2422, and the surface 44 is formed corresponding to the first molding surface 222. The curved surface 42 is coaxial with the curved surface 44.

It is understood that the flat side surface 2442 and 2444 may be omitted. In such case, each of the spacers can have a concave surface to mate with the outer surface of the sleeve 244.

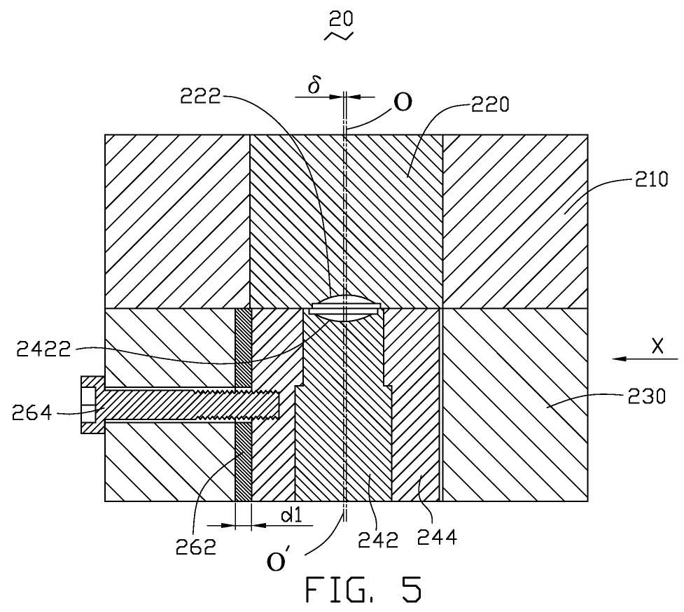

Referring to FIGS. 5 and 6, a concentricity adjusting method using the molding apparatus 20, when an eccentricity between the first molding surface 222 and the second molding surface 2422 occurs, is described in detail as follows.

Referring to FIG. 5, the first mold half 210 and the second mold 230 are assembled together in a manner that the first molding surface 222 faces the second molding surface 2422. In this step, there is a lateral alignment tolerance δ along a direction X in FIG. 5 between the principal axis O of the first molding surface 222 and the principal axis O′ of the second molding surface 2422. The direction X is perpendicular with the flat side surface 2444. The spacer 262 has a thickness d1. The spacer 262 contacts the flat side surface 2444 and the bottom surface 2392 of the groove 239.

The lateral alignment tolerance δ can be measured by a three-coordinate measuring machine. One method of measuring the lateral alignment tolerance δ is to measure coordinate values of the centers of the first and second molding surfaces 222 and 2422 and calculate a distance between the centers of the first and second molding surfaces 222 and 2422 in the X direction, to obtain the lateral alignment tolerance δ. Another method is to measure a lateral alignment tolerance δ′ between two opposite curved surfaces of a lens molded by the molding apparatus 20 and infer the lateral alignment tolerance δ based on the lateral alignment tolerance δ′.

Referring to FIG. 6, the spacer 262 is replaced by a spacer 266 having a thickness d2. The thickness d2 is the thickness d1 plus the lateral alignment tolerance δ, i.e. d2=d1+δ. In such case, the lateral alignment tolerance δ between the first molding surface 222 and the second molding surface 2422 are corrected. Thus, the first molding surface 222 becomes coaxial with the second molding surface 2422.

When the lateral alignment tolerance between the first and second molding surfaces 222 and 2422 is along a direction Y perpendicular with the flat side surface 2442, replacing the spacers 252 by a proper spacer can resolve the problem. Additionally, when the lateral alignment tolerance between the first and second molding surface 222 and 2422 is inclined to the directions X and Y, replacing both the spacers 252, and 262 can resolve the problem.

It is to be understood that the number of the spacer, the corresponding groove defined in the inner surface of the second mold part 230 and the corresponding bolt can be more than two.

In this embodiment, the lateral alignment tolerance between the first molding surface 222 and the second molding surface 2422 can be correctable by replacing the spacers 252, and 262 with the correct thickness spacers. This can avoid modification of the molding apparatus 20, thus increasing efficiency and reducing cost of manufacture.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A molding apparatus comprising:
a first mold half;
a first mold core received in the first mold half, the first mold core having a first molding surface;
a second mold half positioned opposite to the first mold half, the second mold half including a receiving cavity defined therein, a first through hole being defined in the second mold half and in communication with the receiving cavity;
a second mold core received in the receiving cavity of the second mold half, the second mold core having a second molding surface facing the first molding surface, the first molding surface and the second molding surface configured for cooperatively defining a molding cavity between the first molding surface and the second molding surface, the second mold core defining a threaded hole in a peripheral surface thereof, the threaded hole being aligned with the first through hole in the second mold half;
a spacer configured for being positioned between the second mold core and the second mold half; and
a bolt passing through the first through hole and screwed in the threaded hole for securing the second mold core to the second mold half.

2. The molding apparatus of claim 1, wherein the second mold core is slidable in the receiving cavity in a first direction, and a lengthwise direction of the first through hole is perpendicular to the first direction.

3. The molding apparatus of claim 2, further comprising a second spacer and a second bolt, the second mold half defining a second through hole therein, the second mold core defining a second threaded hole in the peripheral surface, the second threaded hole being aligned with the second through hole, the second spacer being positioned between the second mold core and the second mold half, the second bolt passing through the second through hole and screwed in the second threaded hole.

4. The molding apparatus of claim 3, wherein a lengthwise direction of the second through hole is perpendicular to the first direction.

5. The molding apparatus of claim 1, wherein the second mold core comprises a sleeve and a core insert received in the sleeve, the sleeve comprising a flat side surface substantially parallel with a lengthwise direction of the sleeve, the flat side surface being configured for coming into contact the spacer.

6. The molding apparatus of claim 5, wherein a groove is defined in the inner surface of the second mold half in the receiving cavity, the groove extending along a direction parallel with the lengthwise direction of the sleeve and facing towards the flat side surface, a bottom surface of the groove being configured for coming into contact the spacer.

7. The molding apparatus of claim 3, wherein the radius of the bolt is less than the radius of the first through hole, and the radius of the second bolt is less than the radius of the second through hole.

8. A molding apparatus comprising:
a first mold half;
a first mold core received in the first mold half, the first mold core having a first molding surface;
a second mold half positioned opposite to the first mold half, the second mold half including a receiving cavity defined therein, a first through hole being defined in the second mold half and in communication with the receiving cavity;
a second mold core received in the receiving cavity of the second mold half, the second mold core having a second molding surface facing the first molding surface, the first molding surface and the second molding surface configured for cooperatively defining a molding cavity between the first molding surface and the second molding surface, the second mold core comprising a flat side surface, the second mold core defining a threaded hole in the side surface thereof, the threaded hole being aligned with the first through hole in the second mold half;
a spacer configured for being positioned between the threaded hole and the first through hole, the spacer having a thickness custom-tailored for achieving alignment between the second molding surface with the first molding surface; and
a bolt passing through the first through hole and screwed in the threaded hole.
